(19) United States
(12) Patent Application Publication
(10) Pub. No.: US 2006/0034964 A1
(43) Pub. Date: Feb. 16, 2006

(54) Apparatus for the production of transversely ribbed pipes

(75) Inventors: Gunther Hofmann, Hassfurt (DE); Stefan Fosel, Breitbrunn (DE)

Correspondence Address: FULBRIGHT & JAWORSKI, LLP, 1301 MCKINNEY, SUITE 5100, HOUSTON, TX, 77010-3095, US

(73) Assignee: Unicor GmbH Rahn Plastmaschinen, Hassfurt (DE)

(21) Appl. No.: 10/536,346

(22) PCT Filed: Dec. 2, 2003
(86) PCT No.: PCT/DE03/03963

§ 371 Date: May 25, 2005

(30) Foreign Application Priority Data
Dec. 9, 2002 (DE) 102 57 364.6

(51) Int. Cl. B29C 47/00

(52) U.S. Cl. 425/325

(57) ABSTRACT

Described is an apparatus for the production of transversely ribbed tubes, having mold jaw halves which are circulatingly movable in a condition of bearing against each other along two endless guide paths by means of a respective associated drive device. The two guide paths have a common mold section, a respective return section and two respective direction-changing sections. The respective direction-changing section has a direction-changing member having a clothoid-like guide edge in order at the transition between the respective return section and the adjoining direction-changing section and at the transition between the respective direction-changing section and the adjoining mold section and vice-versa to prevent an unwanted jump on the part of the mold jaw halves and in that way to be able to increase the advance speed of the mold jaw halves and improve the productivity of the apparatus.

### CROSS-REFERENCE TO RELATED APPLICATIONS

This application is a national stage filing of PCT/DE03/

### TECHNICAL FIELD

The invention concerns an apparatus for the production of transversely ribbed tubes comprising mold jaw halves which are circulatingly movable in a condition of bearing against each other along two endless guide paths by means of a respective associated drive device, wherein the two guide paths have a common mold section, a respective return section and two respective direction-changing sections, wherein the mold jaw halves along the mold section form a mold passage for the transversely ribbed tube, and the respective direction-changing section has a direction-changing member which is provided with an arcuate guide edge.

### BACKGROUND OF THE INVENTION

Such an apparatus for the production of transversely ribbed tubes having mold jaw halves which are circulatingly movable in a condition of bearing against each other along two endless guide paths by means of a respective drive device is known for example from DE 197 02 647 C1.

In known apparatuses of the general kind set forth the direction-changing members have an arcuate guide edge so that a jump movement of the mold jaw halves is unavoidable at the transitional location between the straight portion of the respective guide path at the mold and return section, and the arcuate guide edge of the respective direction-changing member. That jump movement results from the differing centrifugal forces in respect of the mold jaw halves at the radial inner edge thereof and at the radial outside portion thereof, along the respective direction-changing member. That jump movement results in a corresponding generation of noise. An even worse deficiency however is that the advance speed of the mold jaw halves along the two guide paths is restricted by virtue of that jump movement on the part of the mold jaw halves. That signifies a corresponding limitation on the productivity of known apparatuses of the general kind set forth. A further deficiency, which is not to be disregarded, of such known apparatuses for the production of transversely ribbed tubes is that different temperature conditions prevail during the start-up of the apparatus and during subsequent operation thereof, that is to say during operation the mold jaw halves are at an elevated operating temperature. That elevated operating temperature results in corresponding thermal expansion of the mold jaw halves so that it is necessary for the two guide paths to be increased in length to adapt them to the thermal expansion. For that purpose hitherto the direction-changing members have been manually adjusted. That adjustment requires personnel with a good level of skill.

An apparatus of the kind set forth in the opening part of this specification is known for example from DE 196 19 429 A1. In that known apparatus the mold jaw halves which circulate along the respective guide path are connected together by means of guide elements formed by tension springs. In the entry region into the mold section the direction-changing members are provided with a guide edge which is not circular but approximately elliptical in order to avoid overlapping contact of the mold jaw halves at their edges.

DE 42 24 514 A1 also discloses an apparatus of the kind set forth in the opening part of this specification, in which the mold jaw halves are arranged on chains, by means of which the mold jaw halves are connected together. The chains are guided around direction-changing wheels. There therefore the direction-changing members are formed by the direction-changing wheels which have a circular peripheral edge.

U.S. Pat. No. 4,824,354 discloses a hydraulic press having first and second mold jaws mounted on belts which are circulatingly movable along two endless guide paths by means of an associated drive device. The two guide paths form a common mold section. The direction-changing sections of the two endless guide paths each have a respective direction-changing member formed by a roller with a circular periphery. The direction-changing rollers are resiliently movably mounted to a support structure which is fixed with respect to the machine, to tension the belts.

The object of the invention is to provide an apparatus of the kind set forth in the opening part of this specification, in which a jump movement on the part of the mold jaw halves at the critical transitional region between the respective straight configuration of the two guide paths and the respective direction-changing section adjoining same is avoided.

### BRIEF SUMMARY OF THE INVENTION

In accordance with the invention, in an apparatus of the kind set forth in the opening part of this specification, that object is attained in that the respective direction-changing member has a clothoid-like guide edge.

The clothoid is a curve with an origin having the property that the reciprocal of the radius of curvature at any point on the curve is proportional to the length of the curve arc between the origin and the point on the curve. In other words, at the respective point on the curve, the curvature is proportional to the length of the corresponding arc of the curve between the origin and the point on the curve. Such clothoid curves have hitherto been used in the planning of road traffic systems. In that respect the usual sequence of elements is for example a straight line-clothoid-circular arc or a straight line-clothoid-circular arc-clothoid-straight line.

The fact that, in accordance with the invention, the respective direction-changing member has a clothoid-like guide edge, avoids an unwanted jump movement at the transition between the respective straight portion of the corresponding guide path and the associated direction-changing section, or causes such a jump movement to be shifted into the direction-changing section, so that it is possible to increase the advance speed of the mold jaw halves and in that way enhance the productivity of the apparatus.

In accordance with the invention the guide edge of the respective direction-changing member can have two clothoid portions and a circular arc portion connecting same. It has proven to be desirable if, in such a configuration, a straight portion adjoins the respective clothoid portion, on the side remote from the circular arc portion.

In accordance with the invention the two clothoid portions of the direction-changing member guide edge can be of differing lengths. With such a configuration of the last-mentioned kind, the two straight portions of the direction-changing member guide edge can also be of differing lengths.

In accordance with the invention it is also possible for the two clothoid portions of the direction-changing member guide edge to be at least approximately of equal length. With such an arrangement the two straight portions of the direction-changing member guide edge can also be of at least approximately equal length.

In order to avoid mechanical adjustment of the direction-changing members in dependence on the operating temperature of the mold jaw halves, it is preferable if the respective direction-changing member is connected to a compensating device which compensates for a tolerance play of the mold jaw halves which circulate along the associated guide path, said tolerance play being dependent on the temperature and/or the speed of the mold jaw halves. That compensating device desirably has an air spring which can be subjected to the action of compressed air. Such an air spring is known for example from the prospectus from Festo “Fluidic Muscle Type MAS 0010NH”.

The advantages achieved with the apparatus according to the invention are that an unwanted jump movement of the mold jaw halves along the respective guide path is prevented or at least reduced so that the advance speeds of the mold jaw halves along the two guide paths can be correspondingly increased, this resulting in improved productivity of the apparatus, and that, in a preferred configuration, automatic compensation is effected in respect of temperature-dependent and/or speed-dependent changes in length of the two guide paths so that manual displacements are not necessary.

### BRIEF DESCRIPTION OF THE DRAWINGS

Further details, features and advantages will be apparent from the description hereinafter of an embodiment by way of example of the apparatus according to the invention and essential details thereof, as illustrated in the drawing in which:

FIG. 1 is a view of the apparatus from above,

FIG. 2 shows an essential detail of the apparatus of FIG. 1, and

FIG. 3 shows a perspective view of the detail of FIG. 2 in a view from below, showing only a portion of a mold jaw half and the compensating device.

### DETAILED DESCRIPTION OF THE INVENTION

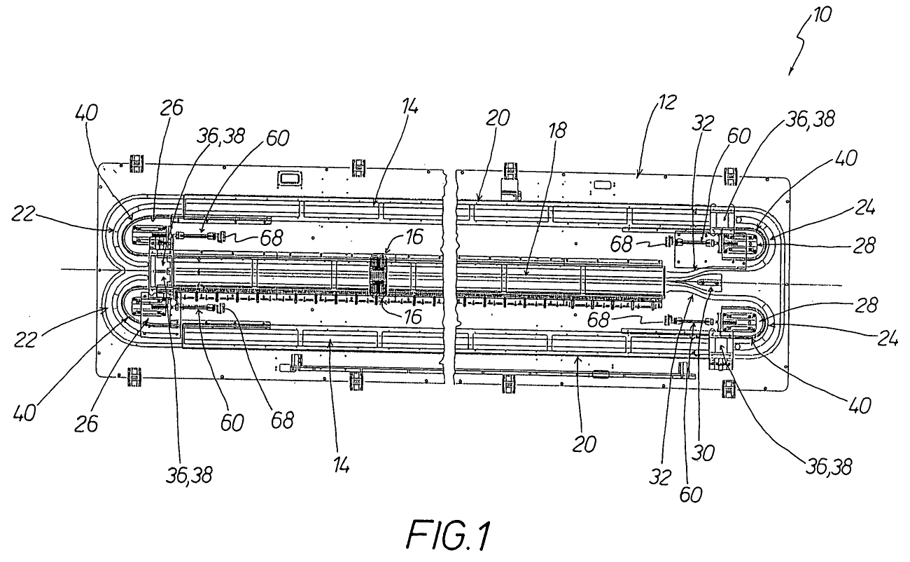

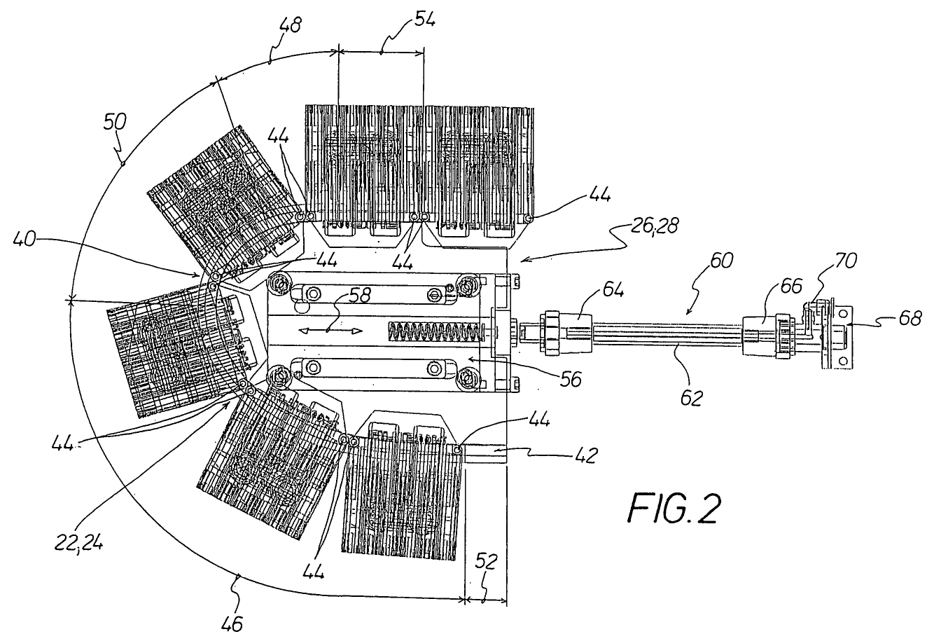

FIG. 1 is a cut-away view from above showing a configuration of the apparatus 10 for the production of transversely ribbed tubes. The apparatus 10 has a base arrangement 12 with two guide paths 14 for mold jaw halves 16, of which only two mold jaw halves 16 are shown in FIG. 2. The mold jaw halves 16 bear against each other along the two guide paths 14. This is shown in FIG. 2 in which a number of mold jaw halves 16 are shown as bearing against each other.

The two guide paths 14 have a common mold section 18 and a respective return section 20. The two return sections 20 are connected to the common mold section 18 by two respective direction-changing sections 22 and 24. Along the common mold section 18 the mold jaw halves 16, in per se known manner, form a mold passage for the transversely ribbed tube to be produced with the apparatus 10.

The direction-changing sections 22 each have a respective direction-changing member 26 and the direction-changing sections 24 each have a respective direction-changing member 28. The direction-changing members 28 are of a smaller transverse dimension than the direction-changing members 26 because a wedge element 30 is provided at the exit of the common mold section 18 and the two direction-changing sections 24 have an expanding portion 32 so that the transversely ribbed tube produced in the mold section 18 can be separated without problem from the mold jaw halves 16.

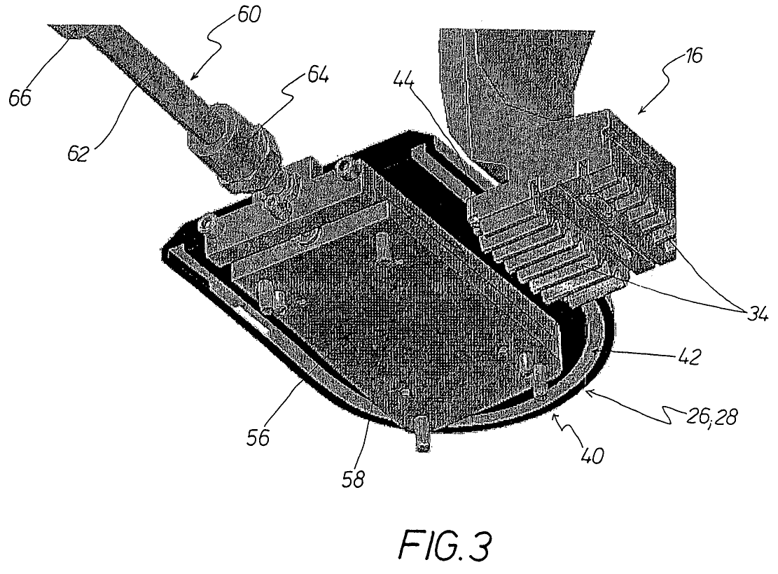

The mold jaw halves 16 of the respective guide path 14 are moved along the guide paths 14 by means of a drive device. For that purpose the mold jaw halves 16 are provided with a tooth arrangement 34 (see FIG. 3) and integrated into the guide paths 14 are gears 36 (see FIG. 1) which are in meshing engagement with the tooth arrangement 34 of the corresponding mold jaw halves 16. The tooth arrangements 34 of the mold jaw halves 16 which are respectively provided in an endless chain and which bear against each other consequently form so-to-speak endless toothed racks. The gears 36 form a drive device 38 for the associated mold jaw halves 16.

As can be seen from FIG. 2 the respective direction-changing member 26 or 28 has a guide edge 40 which is of an arcuate clothoid-like configuration. The guide edge 40 is defined by a guide channel 42, along which guide rollers 44 which are provided in pairs on the mold jaw halves 16 are guided without play. The guide channel 42 can also be seen in FIG. 3. FIG. 3 further shows one of the two guide rollers 44 of the associated mold jaw half 16.

The clothoid-like guide edge 40 formed by the guide channel 42 has two clothoid portions 46 and 48 and a circular arc portion 50 connecting them (see FIG. 2). The two clothoid portions 46 and 48 are of differing lengths. On the side remote from the arc portion 50, a respective straight portion 52 and 54 adjoins the clothoid portion 46 and the clothoid portion 48 respectively.

While, in the case of the two direction-changing members 26 on the intake side of the common mold section 18, the two clothoid portions 46 and 48 and the straight portions 62 and 54 are of different lengths, in the case of the direction-changing members 28 on the discharge side of the common mold section 18 the clothoid portions 46 and 48 and the straight portions 52 and 54 are each of at least approximately the same length (see FIG. 1).

The respective direction-changing member 26 and 28 is linearly movably arranged on a base element 56 fixed with respect to the machine (see in particular FIG. 3). That linear mobility is indicated by the double-headed arrow 58 in FIG. 3. The respective direction-changing member 26 and 28 is connected to a compensating device 60 which is provided for automatically compensating for a tolerance play of the mold jaw halves 16, along the associated guide path 14, said tolerance play being dependent on the temperature and/or the speed of the mold jaw halves 16. The compensating device 60 has an air spring 62 which at each of its two mutually remote ends has a respective connection fitting 64, 66. The connection fitting 64 is connected to an associated direction-changing member 26 and 28 respectively. The connecting fitting 66 is connected to a bracket 68 which is fixed with respect to the machine and has a compressed air connection 70. The air spring 62 is subjected to the action of compressed air, thus affording a reduction in the length of the air spring 62 between its connection fittings 64 and 66.

1. An apparatus for the production of transversely ribbed tubes, comprising:
mold jaw halves which are circulatingly movable in a condition of bearing against each other along two endless guide paths by means of a respective associated drive device, wherein the two guide paths have a common mold section, a respective return section and two respective direction-changing sections, wherein the mold jaw halves form along the mold section a mold passage for the transversely ribbed tube and the respective direction-changing section has a direction-changing member provided with an arcuate guide edge,
wherein the guide edge of the respective direction-changing member has a two clothoid portions and a circular arc portion connecting same.

2. The apparatus as set forth in claim 1, wherein on the side remote from the circular arc portion a straight portion adjoins the respective clothoid portion.

3. The apparatus as set forth in claim 1, wherein the two clothoid portions of the direction-changing member guide edge are of differing lengths.

4. The apparatus as set forth in claim 2, wherein the two straight portions of the direction-changing member guide edge are of differing lengths.

5. The apparatus as set forth in claim 1, wherein the two clothoid portions of the direction-changing member guide edge are at least approximately of equal length.

6. The apparatus as set forth in claim 2, wherien the two straight portions of the direction-changing member guide edge are at least approximately of equal length.

7. The apparatus as set forth in claims 1, wherein the respective direction-changing member is connected to a compensating device which compensates for a tolerance play of the mold jaw halves which circulate along the associated guide path, said tolerance play being dependent on the temperature of the mold jaw halves.

8. The apparatus as set forth in claim 7, wherein the compensating device has an air spring which can be subjected to the action of compressed air.

9. The apparatus as set forth in claim 1, wherein the respective direction-changing member is connected to a compensating device which compensates for a tolerance play of the mold jaw halves which circulate along the associated guide path, said tolerance play being dependent on the speed of the mold jaw halves.
